(19) United States
(12) Patent Application Publication
(10) Pub. No.: US 2020/0334718 A1
(43) Pub. Date: Oct. 22, 2020

(54) Identification of Silent Sufferers of a Customer Dataset

(71) Applicant: Dell Products L.P., Round Rock, TX (US)

(72) Inventor: Venkata Chandra Sekar Rao, Bengaluru (IN)

(73) Assignee: Dell Products L.P., Round Rock, TX (US)

(21) Appl. No.: 16/385,672

(22) Filed: Apr. 16, 2019

(51) Int. Cl. G06Q 30/02

(52) U.S. Cl. CPC G06Q 30/0282

(57) ABSTRACT

Technology that facilitates identification of silent sufferers of a customer dataset is disclosed. Exemplary implementations may: obtain golden set that includes non-silent sufferers, which are customers who have provided negative ratings and are classified as sufferers, which are customers with bad customer experiences (BCEs) that likely caused lesser or terminated their customer relationships; obtain an unlabeled set that includes unclassified customers who have not provided negative ratings of their customer experience; based on similarity to the non-silent sufferers, identify a silent-suffering subset of the unlabeled set as silent sufferers, which are customers who have not provided negative ratings of their customer experience, but are likely to have had BCEs that likely caused a lesser or terminated customer relationship; report the customers of the identified silent-suffering subset as silent sufferers; and initiate actions toward the silent sufferers to improve the customer experience of the identified silent sufferers.

### BACKGROUND

Customers frequently give feedback to companies with which they do business. Commonly, a company may actively and aggressively reach out to customers (e.g., via a telephone call or email campaign) to get their feedback. Also, customers seek out ways to give companies feedback and ratings. For example, a traveler may rate a hotel via a mobile app designed specifically to rate travel businesses.

Of course, sometimes the feedback is positive and sometimes it is negative. After giving negative feedback to a company, it is not uncommon for a customer to reduce or end their relationship with that company. However, because of the negative feedback, the company is afforded an opportunity to reach out to that customer and attempt to win back their favor. Unfortunately, some customers reduce or end their relationship with a company without giving any negative feedback.

### SUMMARY

One aspect of the present disclosure relates to a system configured to facilitate identification of silent sufferers of a customer dataset. The system may include one or more hardware processors configured by machine-readable instructions. The processor(s) may be configured to obtain a golden set that includes data regarding non-silent sufferers, which are customers of an entity who have provided negative ratings of their customer experience with the entity and are classified as sufferers, which are customers that had one or more bad customer experiences (BCEs) with the entity that likely caused lesser or terminated customer relationships with the entity. The processor(s) may be configured to obtain an unlabeled set that includes data regarding unclassified customers of the entity who have not provided negative ratings of their customer experience with the entity. The processor(s) may be configured to, based on similarity to the non-silent sufferers, identify a silent-suffering subset of the data regarding customers of the unlabeled set as silent sufferers, which are customers of the entity who have not provided negative ratings of their customer experience with the entity, but are likely to have had one or more BCEs with the entity that likely caused a lesser or terminated customer relationship with the entity. The processor(s) may be configured to report the customers of the identified silent-suffering subset as silent sufferers. The processor(s) may be configured to initiate actions by the entity toward the silent sufferers of the identified silent-suffering subset to improve the customer experience of the identified silent sufferers.

Another aspect of the present disclosure relates to a method that facilitates identification of silent sufferers of a customer dataset. The method may include obtaining a golden set that includes data regarding non-silent sufferers, which are customers of an entity who have provided negative ratings of their customer experience with the entity and are classified as sufferers, which are customers that had one or more bad customer experiences (BCEs)s with the entity that likely caused lesser or terminated customer relationships with the entity. The method may include obtaining an unlabeled set that includes data regarding unclassified customers of the entity who have not provided negative ratings of their customer experience with the entity. The method may include, based on similarity to the non-silent sufferers, identifying a silent-suffering subset of the data regarding customers of the unlabeled set as silent sufferers, which are customers of the entity who have not provided negative ratings of their customer experience with the entity, but are likely to have had one or more BCEs with the entity that likely caused a lesser or terminated customer relationship with the entity. The method may include reporting the customers of the identified silent-suffering subset as silent sufferers. The method may include initiating actions by the entity toward the silent sufferers of the identified silent-suffering subset to improve the customer experience of the identified silent sufferers.

Yet another aspect of the present disclosure relates to a non-transient computer-readable storage medium having instructions embodied thereon, the instructions being executable by one or more processors to perform a method that facilitates identification of silent sufferers of a customer dataset. The method may include obtaining a golden set that includes data regarding non-silent sufferers, which are customers of an entity who have provided negative ratings of their customer experience with the entity and are classified as sufferers, which are customers that had one or more bad customer experiences (BCEs) with the entity that likely caused lesser or terminated customer relationships with the entity. The method may include obtaining an unlabeled set that includes data regarding unclassified customers of the entity who have not provided negative ratings of their customer experience with the entity. The method may include, based on similarity to the non-silent sufferers, identifying a silent-suffering subset of the data regarding customers of the unlabeled set as silent sufferers, which are customers of the entity who have not provided negative ratings of their customer experience with the entity, but are likely to have had one or more BCEs with the entity that likely caused a lesser or terminated customer relationship with the entity. The method may include reporting the customers of the identified silent-suffering subset as silent sufferers. The method may include initiating actions by the entity toward the silent sufferers of the identified silent-suffering subset to improve the customer experience of the identified silent sufferers.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured to facilitate identification of silent sufferers of a customer dataset, in accordance with one or more implementations.

FIG. 2 illustrates an example of data flow of modeling suitable to work with a system configured to facilitate identification of silent sufferers of a customer dataset, in accordance with one or more implementations.

FIG. 3 illustrates a method that facilitates identification of silent sufferers of a customer dataset, in accordance with one or more implementations.

The Detailed Description references the accompanying figures. In the figures, the left-most digit(s) of a reference number identifies the figure in which the reference number first appears. The same numbers are used throughout the drawings to reference like features and components.

### DETAILED DESCRIPTION

A technology that facilitates the identification of silent sufferers of a customer dataset is disclosed. Exemplary implementations may: obtain a golden set that includes data regarding non-silent sufferers, which are customers of an entity who have provided negative ratings of their customer experience with the entity and are classified as sufferers, which are customers that had one or more bad customer experiences (BCEs) with the entity that likely caused lesser or terminated customer relationships with the entity; obtain an unlabeled set that includes data regarding unclassified customers of the entity who have not provided negative ratings of their customer experience with the entity; based on similarity to the non-silent sufferers, identify a silent-suffering subset of the data regarding customers of the unlabeled set as silent sufferers, which are customers of the entity who have not provided negative ratings of their customer experience with the entity, but are likely to have had one or more BCEs with the entity that likely caused a lesser or terminated customer relationship with the entity; report the customers of the identified silent-suffering subset as silent sufferers; and initiate actions by the entity toward the silent sufferers of the identified silent-suffering subset to improve the customer experience of the identified silent sufferers.

There are some indications that it costs six to seven times more to acquire a new customer than to keep an existing one. Many customers voluntarily leave in response to one or more bad customer experiences (BCE), such as delayed shipments, unexpected fees, damaged goods, rude customer service, poor technical support, poor website navigation, payment failures, and the like.

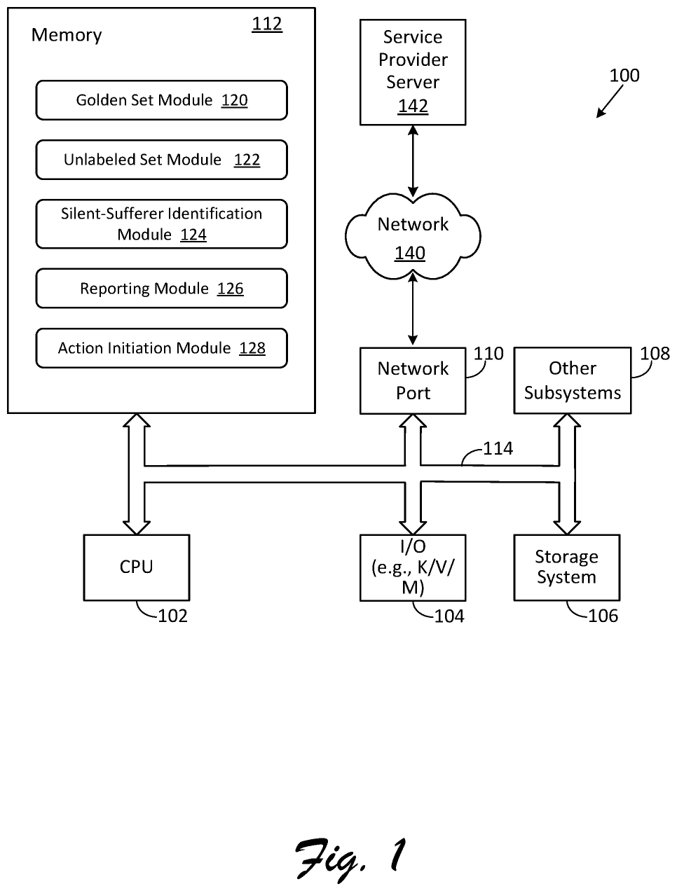

FIG. 1 is a generalized illustration of an information handling system that can be used to implement the example system 100. This example system configured to that facilitates identification of silent sufferers of a customer dataset in accordance with one or more implementations.

The example system 100 includes a processor (e.g., central processor unit or “CPU”) 102, input/output (I/O) devices 104, such as a display, a keyboard, a mouse, and associated controllers, a storage system 106 (e.g., a hard drive), and various other subsystems 108. In various embodiments, the example routing-script verification system 100 also includes network port 110 operable to connect to a network 140, which is likewise accessible by a service provider server 142. The example routing-script verification system 100 likewise includes system memory 112, which is interconnected to the foregoing via one or more buses 114.

System memory 112 may store data and machine-readable instructions. The example system 100 may be configured by the machine-readable instructions. Machine-readable instructions may include one or more instruction modules. The instruction modules may include computer program modules. The instruction modules may include one or more of golden set module 120, unlabeled set module 122, silent-sufferer identification module 124, reporting module 126, action initiation module 128, and/or other instruction modules.

Golden set module 120 may be configured to obtain a golden set that includes data regarding non-silent sufferers. Non-silent sufferers are customers of an entity 1) who have provided negative ratings of their customer experience with the entity and 2) are classified as sufferers. A sufferer is a customer that had one or more bad customer experiences (BCEs) with the entity that likely caused lesser or terminated customer relationships with the entity.

As used herein, the “golden set” is a convenient name that refers to a subset of a customer dataset of an entity that contains customer records of customers that have two properties associated therewith: First, one or more negative ratings. Second, they have been classified as sufferers.

An entity may be, for example, an enterprise, business, or organization offering goods and/or services to customers in an exchange. By way of non-limiting example, the entity may include a business, company, online retailer, online wholesaler, cooperative, exchange, charity, foundation, or some combination thereof.

A customer may be, for example, an individual or organization purchases, acquires, utilizes, receives, consumes, or otherwise uses the goods and/or services of an entity. The customer relationship may include the history of the exchanges between the entity and the customer. The customer relationship may include the customer's subjective opinion of the entity and the likelihood of continued or improved rate of exchanges in the future.

In an effort to better understand their customer relationships, an entity may seek to obtain customer feedback. This feedback may come directly from customers about the satisfaction or dissatisfaction they feel with a product or a service. Customer comments and complaints given to an entity are a helpful resource for improving and addressing the needs and wants of their customers. This feedback may be procured through written or oral surveys, online forms, emails, letters, or phone calls from the customer to the company.

Customer feedback often includes a rating of the customer relationship and/or of particular customer experiences with the entity. These ratings may be categorized as positive, neutral, or negative. As used herein, a positive rating is one that is considered associated with an improved likelihood of the customer relationship. Conversely, a negative rating is one that is considered associated with an improved likelihood of the customer relationship.

For example, one may consider a rating scale of one to ten with one being the best and ten being the worst. On such a scale, ratings seven to ten may be considered negative ratings. Of course, the particular numbers or values used in an implementation may vary.

It is not uncommon for customers to give a negative rating in response to one or more bad customer experiences (BCEs). A customer experience involves an interaction between the customer and the entity (or a 3rd-party agent or representative of the entity). A customer experience may involve, for example, an interaction with goods and/or services associated with the entity (or a 3rd-party agent or representative of the entity).

When a customer experienced a customer interaction that leaves the customer with a poor or unfavorable impression of the entity or some aspect of that entity, then that interaction is called a bad customer experience (BCE) herein. Examples of BCEs include delayed shipments, unexpected fees, damaged goods, rude customer service, poor technical support, poor website navigation, payment failures, and the like.

While any BSE can affect the customer relationship, some BSEs may be categorized as likely to cause a lessening or termination of the customer relationship. These may be determined heuristically and/or via analysis of BSEs that actually lead to the lessening or termination of the customer relationship with non-silent sufferers.

Often, one or more BSEs contribute to a lessening or termination of the customer relationship between the customer that experienced the BSEs and the entity. This customer is called a sufferer. Indeed, a sufferer is a customer that had one or more bad customer experiences (BCEs) with the entity that likely caused lesser or terminated customer relationships with the entity.

A lessen relationship may be, for example, one with a downward trend in, for example, purchase frequency, purchase volume, price sensitivity, less service, and the like. A terminated customer relationship involves a customer who appears to no longer acquire the goods and/or services of the entity.

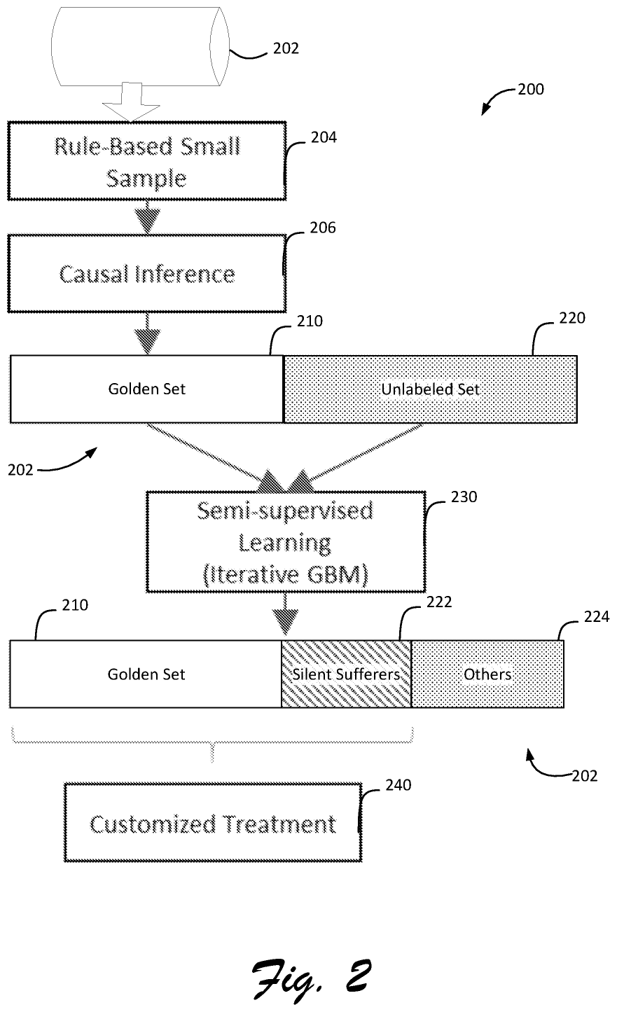

FIG. 2 is an illustration of a data flow 200 of modeling of silent sufferers based on the non-silent sufferers of the golden set. The data flow 200 starts with a database or dataset 202 of customers of the entity. The customer dataset 202 includes customer records of customers of the entity. As shown at the top of FIG. 2, the records of the customer dataset 202 are not yet classified as sufferers, non-silent sufferers, nor silent sufferers.

The data in the records regarding each customer may include fields with historical data of the customer relationship with the entity. In some implementations, by way of non-limiting example, the fields are selected from a group may consist of gross merchandise volume bought item count, purchasing days bad buying experience history, delayed delivery of orders, spend capacity, transaction details, purchase data, item price, category seasonality, condition, quantity, shipping methods, returns, contact frequency and engagement, e-commerce behaviors, browse history, bid history, offer history, watch history, message history, cart history, wish list, search history, demographics, and acquisition channel.

Golden set module 120 may obtain the golden set by extracting it from the customer dataset 202. That is, the golden set module 120 examines the customer records to find the customers that both 1) gave negative feedback and 2) had a BSE that is likely to make them a sufferer.

Golden set module 120 may be configured to identify a negative-rating/BCE subset of the data regarding customers of the entity as those who have provided negative ratings of their customer experience with the entity and that are likely to be sufferers.

As shown in FIG. 2, the identifying a negative-rating/BCE subset may include implementation of rule-based system 204 to inference a causal connection 206 between one or more BCEs of a customer with lesser or terminated customer relationships with the entity. The negative-rating/BCE may be the golden set 210 of the customer dataset 202.

A rule-based system may include a list of customers who provided detractor or negative rating. A causal inference may be drawn for example when the rating sufficiently negative (e.g., exceed a threshold) and customer experienced a BCE on the last purchase day. Note that the worse the negative rating the greater the likelihood (e.g., causal inference) that the customer relationship is on a downward trend. Indeed, there is a linear relationship between the degree of negative rating and the cumulative BCEs that a customer has experienced.

The golden set 210 includes both happy customers and the non-silent sufferers. The remainder of the customer dataset 202 is an unlabeled set 220. The sufferers in the unlabeled set 220 would be silent ones.

Unlabeled set module 122 may be configured to obtain an unlabeled set that includes data regarding unclassified customers of the entity who have not provided negative ratings of their customer experience with the entity. The unlabeled set 220 of FIG. 2 is an example of the obtained unlabeled set.

The “unlabeled set” is a name used herein for this set. Unclassified customers are customer records that have not yet been classified as a sufferer, silent sufferer, or non-silent sufferer.

Silent-sufferer identification module 124 may be configured to, based on similarity to the non-silent sufferers, identify a silent-suffering subset of the data regarding customers of the unlabeled set as silent sufferers. Silent sufferers are sufferers that have not provided a negative rating or feedback. That is, silent sufferers are customers of the entity who have not provided negative ratings of their customer experience with the entity, but are likely to have had one or more BCEs with the entity that likely caused a lesser or terminated customer relationship with the entity.

The silent sufferers who have had BSEs choose to both stay silent (e.g., provide no negative feedback) and lessen or terminate the relationship. The technology described herein presumes that the silent sufferer's behavior and experiences, except for their silence, are similar to that of the non-silent sufferers. Thus, the silent-sufferer identification module 124 locates customers amongst the silent ones whose behavior and experiences are most similar to that of the non-silent sufferers,

The identifying of the silent sufferers may include determining the similarity between customers of the unlabeled set to the non-silent sufferers. This may involve comparing the customers of the unlabeled set and some portion of the non-silent sufferers of the golden set. The identifying of the silent sufferers may include, based on the determined similarity, identifying the customers of the unlabeled set as most similar to the non-silent sufferers when their similarity exceeds a similarity threshold. For example, the similarity threshold may be 70%, 80%, 90%, 95%, or a greater degree of similarity of behavior and experiences. There may be key similarity measures (e.g., BSE or relationship history) that are weighting factors.

The identifying a silent-suffering subset may include merging a portion of the non-silent customers from the golden set into a mix set with the customers of the unlabeled set. This portion of the non-silent customers may be called “spies.”

The identifying a silent-suffering subset may include performing semi-supervised learning 230 on the mixed set to identify the silent-suffering subset Indeed, the iterative gradient boosting machine or method (GBM) may be performed.

Rather than manually labeling each customer record, the iterative GBM chooses a small sample out of a collection of unlabeled records and assigns them a label. The iterative GBM trains the model and predicts the label for the remaining set of records, using a boosting method which is sequential first identify label for few unknown records based on few known records, again perform same to improve prediction accuracy. In this context also first taking subset (i.e., the “spies”) from golden set adding to unknown set and train the model again by adding another subset of golden set to unknown set and train sequentially.

As a result, the customer dataset 202 is divided into golden set 210, silent sufferers 222, and other customer records 224. More precisely, the unlabeled set 220 is divided into the silent sufferers 222 other customer records 224

Reporting module 126 may be configured to report the customers of the identified silent-suffering subset as silent sufferers.

Action initiation module 128 may be configured to initiate actions by the entity toward the silent sufferers of the identified silent-suffering subset to improve the customer experience of the identified silent sufferers. As depicted in FIG. 2, the silent sufferers 222 will get a customized treatment that is designed to improve the customer relationship.

By way of non-limiting example, the actions by the entity towards the silent sufferers may be selected from a group consisting of refunds, discount offers, coupons, customer service contact, and the like.

Storage system 106 may comprise non-transitory storage media that electronically stores information. The electronic storage media of storage system 106 may include one or both of system storage that is provided integrally (i.e., substantially non-removable) from a computer and/or removable storage that is removably connectable to a computer via, for example, a port (e.g., a USB port, a firewire port, etc.) or a drive (e.g., a disk drive, etc.). Storage system 106 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 126 may include one or more virtual storage resources (e.g., cloud storage, a virtual private network, and/or other virtual storage resources). Storage system 106 may store software algorithms, information determined by processor(s) 102, information received from a server, information received from a client computing platform(s), and/or other information that enables the example routing-script verification system 100 to function as described herein.

Processor(s) 102 may be configured to provide information processing capabilities. As such, processor(s) 102 may include one or more of a digital processor, an analog processor, a digital circuit designed to process information, an analog circuit designed to process information, a state machine, and/or other mechanisms for electronically processing information. Although processor(s) 102 is shown in FIG. 1 as a single entity, this is for illustrative purposes only. In some implementations, processor(s) 102 may include a plurality of processing units. These processing units may be physically located within the same device, or processor(s) 102 may represent processing functionality of a plurality of devices operating in coordination.

Processor(s) 128 may be configured to execute modules 120, 122, 124, 126, and/or 128, and/or other modules. Processor(s) 102 may be configured to execute modules 120, 122, 124, 126, and/or 128, and/or other modules by software; hardware; firmware; some combination of software, hardware, and/or firmware; and/or other mechanisms for configuring processing capabilities on processor(s) 102. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 120, 122, 124, 126, and/or 128 are illustrated in FIG. 1 as being implemented within a single processing unit, in implementations in which processor(s) 102 includes multiple processing units, one or more of modules 120, 122, 124, 126, and/or 128 may be implemented remotely from the other modules. The description of the functionality provided by the different modules 120, 122, 124, 126, and/or 128 described below is for illustrative purposes, and is not intended to be limiting, as any of modules 120, 122, 124, 126, and/or 128 may provide more or less functionality than is described. For example, one or more of modules 120, 122, 124, 126, and/or 128 may be eliminated, and some or all of its functionality may be provided by other ones of modules 120, 122, 124, 126, and/or 128. As another example, processor(s) 102 may be configured to execute one or more additional modules that may perform some or all of the functionality attributed below to one of modules 120, 122, 124, 126, and/or 128.

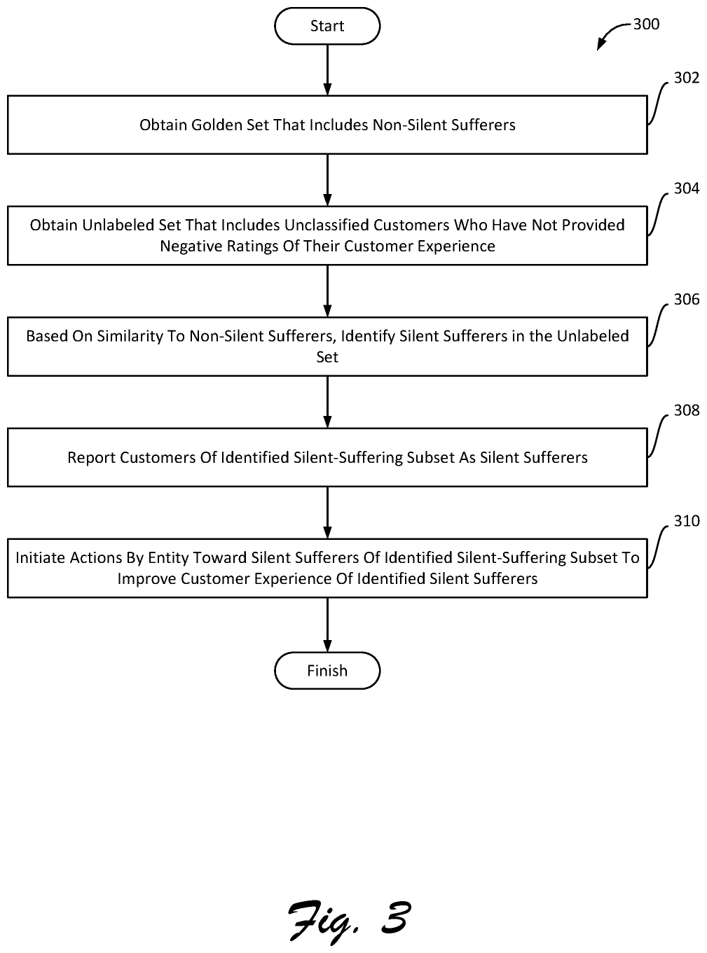

FIG. 3 illustrates a method 300 that facilitates identification of silent sufferers of a customer dataset, in accordance with one or more implementations. The operations of method 300 presented below are intended to be illustrative. In some implementations, method 300 may be accomplished with one or more additional operations not described, and/or without one or more of the operations discussed. Additionally, the order in which the operations of method 300 are illustrated in FIG. 3 and described below is not intended to be limiting.

In some implementations, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

An operation 302 may include obtaining a golden set that includes data regarding non-silent sufferers, which are customers of an entity who have provided negative ratings of their customer experience with the entity and are classified as sufferers, which are customers that had one or more BCEs with the entity that likely caused lesser or terminated customer relationships with the entity, Operation 302 may be performed by one or more hardware processors configured by machine-readable instructions including a module that is the same as or similar to golden set module 120, in accordance with one or more implementations.

An operation 304 may include obtaining an unlabeled set that includes data regarding unclassified customers of the entity who have not provided negative ratings of their customer experience with the entity. Operation 304 may be performed by one or more hardware processors configured by machine-readable instructions including a module that is the same as or similar to golden set module 120, in accordance with one or more implementations.

An operation 306 may include based on similarity to the non-silent sufferers, identifying a silent-suffering subset of the data regarding customers of the unlabeled set as silent sufferers, which are customers of the entity who have not provided negative ratings of their customer experience with the entity, but are likely to have had one or more BCEs with the entity that likely caused a lesser or terminated customer relationship with the entity. Operation 306 may be performed by one or more hardware processors configured by machine-readable instructions including a module that is the same as or similar to silent-sufferer identification module 124, in accordance with one or more implementations.

An operation 308 may include reporting the customers of the identified silent-suffering subset as silent sufferers. Operation 308 may be performed by one or more hardware processors configured by machine-readable instructions including a module that is the same as or similar to reporting module 126, in accordance with one or more implementations.

An operation 310 may include initiating actions by the entity toward the silent sufferers of the identified silent-suffering subset to improve the customer experience of the identified silent sufferers. Operation 310 may be performed by one or more hardware processors configured by machine-readable instructions including a module that is the same as or similar to action initiation module 128, in accordance with one or more implementations.

Additional and Alternative Implementation Notes

purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

In the above description of example implementations, for purposes of explanation, specific numbers, materials configurations, and other details are set forth in order to better explain the present disclosure. However, it will be apparent to one skilled in the art that the subject matter of the claims may be practiced using different details than the examples ones described herein. In other instances, well-known features are omitted or simplified to clarify the description of the example implementations.

The terms “techniques” or “technologies” may refer to one or more devices, apparatuses, systems, methods, articles of manufacture, and/or executable instructions as indicated by the context described herein.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

These processes are illustrated as a collection of blocks in a logical flow graph, which represents a sequence of operations that may be implemented in mechanics alone, with hardware, and/or with hardware in combination with firmware or software. In the context of software/firmware, the blocks represent instructions stored on one or more non-transitory computer-readable storage media that, when executed by one or more processors or controllers, perform the recited operations.

Note that the order in which the processes are described is not intended to be construed as a limitation, and any number of the described process blocks can be combined in any order to implement the processes or an alternate process. Additionally, individual blocks may be deleted from the processes without departing from the spirit and scope of the subject matter described herein.

As will be appreciated by one skilled in the art, the technology described herein may be embodied as a method, system, or computer program product. Accordingly, embodiments of the technology described herein may be implemented entirely in hardware or a combination of hardware and software (including firmware, resident software, micro-code, etc.) These various embodiments may all generally be referred to herein as a “circuit,” “module,” or “system.” Furthermore, the technology described herein may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the technology described herein may be written in an object oriented programming language such as Java, Smalltalk, C++ or the like. However, the computer program code for carrying out operations of the technology described herein may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the technology described herein are described with reference to flowchart illustrations and/or block diagrams of methods, apparatus (systems) and computer program products according to embodiments of the technology described herein. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The technology described herein is well adapted to attain the advantages mentioned as well as others inherent therein. While the technology described herein has been depicted, described, and is defined by reference to particular embodiments of the technology described herein, such references do not imply a limitation on the technology described herein, and no such limitation is to be inferred. The technology described herein is capable of considerable modification, alteration, and equivalents in form and function, as will occur to those ordinarily skilled in the pertinent arts. The depicted and described embodiments are examples only, and are not exhaustive of the scope of the technology described herein.

Consequently, the technology described herein is intended to be limited only by the spirit and scope of the appended claims, giving full cognizance to equivalents in all respects.

What is claimed is:

1. A system configured to facilitate identification of silent sufferers of a customer dataset, the system comprising:
one or more hardware processors configured by machine-readable instructions to:
obtain a golden set that includes data regarding non-silent sufferers, which are customers of an entity who have provided negative ratings of their customer experience with the entity and are classified as sufferers, which are customers that had one or more bad customer experiences (BCEs) with the entity that likely caused lesser or terminated customer relationships with the entity;
obtain an unlabeled set that includes data regarding unclassified customers of the entity who have not provided negative ratings of their customer experience with the entity;
based on similarity to the non-silent sufferers, identify a silent-suffering subset of the data regarding customers of the unlabeled set as silent sufferers, which are customers of the entity who have not provided negative ratings of their customer experience with the entity, but are likely to have had one or more BCEs with the entity that likely caused a lesser or terminated customer relationship with the entity;
report the customers of the identified silent-suffering subset as silent sufferers; and
initiate actions by the entity toward the silent sufferers of the identified silent-suffering subset to improve the customer experience of the identified silent sufferers.

2. The system of claim 1, wherein the one or more hardware processors are further configured by machine-readable instructions to:
obtain of a set of data regarding customers of the entity;
identify a negative-rating/BCE subset of the data regarding customers of the entity as customers of the entity who have provided negative ratings of their customer experience with the entity and that are likely to be sufferers;
provide the negative-rating/BCE subset as the golden set.

3. The system of claim 2, wherein the identifying a negative-rating/BCE subset includes implementation of a rule-based system to inference a causal connection between one or more BCEs of a customer with lesser or terminated customer relationships with the entity.

4. The system of claim 1, wherein the identifying a silent-suffering subset includes determining similarity between customers of the unlabeled set to the non-silent sufferers is determined by comparing the customers of the unlabeled set and some portion of the non-silent sufferers of the golden set;
wherein the identifying a silent-suffering subset includes, based on the determined similarity, identifying the customers of the unlabeled set as most similar to the non-silent sufferers when their similarity exceeds a similarity threshold.

5. The system of claim 1, wherein the identifying a silent-suffering subset includes merging a portion of the non-silent customers from the golden set into a mix set with the customers of the unlabeled set;
wherein the identifying a silent-suffering subset includes performing semi-supervised learning on the mixed set to identify the silent-suffering subset.

6. The system of claim 1, wherein the actions by the entity towards the silent sufferers is selected from a group consisting of refunds, discount offers, coupons, customer service contact, and combination thereof.

7. The system of claim 1, wherein the data regarding customers includes fields with historical data of the customer relationship with the entity, the fields are selected from a group consisting of gross merchandise volume bought item count, purchasing days bad buying experience history, delayed delivery of orders, spend capacity, transaction details, purchase data, item price, category seasonality, condition, quantity, shipping methods, returns, contact frequency and engagement, e-commerce behaviors, browse history, bid history, offer history, watch history, message history, cart history, wish list, search history, demographics, and acquisition channel.

8. A method that facilitates identification of silent sufferers of a customer dataset, the method comprising:
obtaining a golden set that includes data regarding non-silent sufferers, which are customers of an entity who have provided negative ratings of their customer experience with the entity and are classified as sufferers, which are customers that had one or more bad customer experiences (BCEs) with the entity that likely caused lesser or terminated customer relationships with the entity;
obtaining an unlabeled set that includes data regarding unclassified customers of the entity who have not provided negative ratings of their customer experience with the entity;
based on similarity to the non-silent sufferers, identifying a silent-suffering subset of the data regarding customers of the unlabeled set as silent sufferers, which are customers of the entity who have not provided negative ratings of their customer experience with the entity, but are likely to have had one or more BCEs with the entity that likely caused a lesser or terminated customer relationship with the entity;
reporting the customers of the identified silent-suffering subset as silent sufferers; and
initiating actions by the entity toward the silent sufferers of the identified silent-suffering subset to improve the customer experience of the identified silent sufferers.

9. The method of claim 8, further comprising:
obtaining of a set of data regarding customers of the entity;
identifying a negative-rating/BCE subset of the data regarding customers of the entity as customers of the entity who have provided negative ratings of their customer experience with the entity and that are likely to be sufferers;
providing the negative-rating/BCE subset as the golden set.

10. The method of claim 9, wherein the identifying a negative-rating/BCE subset includes implementation of a rule-based system to inference a causal connection between one or more BCEs of a customer with lesser or terminated customer relationships with the entity.

11. The method of claim 8, wherein the identifying a silent-suffering subset includes determining similarity between customers of the unlabeled set to the non-silent sufferers is determined by comparing the customers of the unlabeled set and some portion of the non-silent sufferers of the golden set;
wherein the identifying a silent-suffering subset includes, based on the determined similarity, identifying the customers of the unlabeled set as most similar to the non-silent sufferers when their similarity exceeds a similarity threshold.

12. The method of claim 8, wherein the identifying a silent-suffering subset includes merging a portion of the non-silent customers from the golden set into a mix set with the customers of the unlabeled set;
wherein the identifying a silent-suffering subset includes performing semi-supervised learning on the mixed set to identify the silent-suffering subset.

13. The method of claim 8, wherein the actions by the entity towards the silent sufferers is selected from a group consisting of refunds, discount offers, coupons, customer service contact, and combination thereof.

14. The method of claim 8, wherein the data regarding customers includes fields with historical data of the customer relationship with the entity, the fields are selected from a group consisting of gross merchandise volume bought item count, purchasing days bad buying experience history, delayed delivery of orders, spend capacity, transaction details, purchase data, item price, category seasonality, condition, quantity, shipping methods, returns, contact frequency and engagement, e-commerce behaviors, browse history, bid history, offer history, watch history, message history, cart history, wish list, search history, demographics, and acquisition channel.

15. A non-transient computer-readable storage medium having instructions embodied thereon, the instructions being executable by one or more processors to perform a method that facilitates identification of silent sufferers of a customer dataset, the method comprising:
obtaining a golden set that includes data regarding non-silent sufferers, which are customers of an entity who have provided negative ratings of their customer experience with the entity and are classified as sufferers, which are customers that had one or more bad customer experiences (BCEs) with the entity that likely caused lesser or terminated customer relationships with the entity;
obtaining an unlabeled set that includes data regarding unclassified customers of the entity who have not provided negative ratings of their customer experience with the entity;
based on similarity to the non-silent sufferers, identifying a silent-suffering subset of the data regarding customers of the unlabeled set as silent sufferers, which are customers of the entity who have not provided negative ratings of their customer experience with the entity, but are likely to have had one or more BCEs with the entity that likely caused a lesser or terminated customer relationship with the entity;
reporting the customers of the identified silent-suffering subset as silent sufferers; and
initiating actions by the entity toward the silent sufferers of the identified silent-suffering subset to improve the customer experience of the identified silent sufferers.

16. The computer-readable storage medium of claim 15, wherein the method further comprises:
obtaining of a set of data regarding customers of the entity;
identifying a negative-rating/BCE subset of the data regarding customers of the entity as customers of the entity who have provided negative ratings of their customer experience with the entity and that are likely to be sufferers;
providing the negative-rating/BCE subset as the golden set.

17. The computer-readable storage medium of claim 16, wherein the identifying a negative-rating/BCE subset includes implementation of a rule-based system to inference a causal connection between one or more BCEs of a customer with lesser or terminated customer relationships with the entity.

18. The computer-readable storage medium of claim 15, wherein the identifying a silent-suffering subset includes determining similarity between customers of the unlabeled set to the non-silent sufferers is determined by comparing the customers of the unlabeled set and some portion of the non-silent sufferers of the golden set;
wherein the identifying a silent-suffering subset includes, based on the determined similarity, identifying the customers of the unlabeled set as most similar to the non-silent sufferers when their similarity exceeds a similarity threshold.

19. The computer-readable storage medium of claim 15, wherein the identifying a silent-suffering subset includes merging a portion of the non-silent customers from the golden set into a mix set with the customers of the unlabeled set;
wherein the identifying a silent-suffering subset includes performing semi-supervised learning on the mixed set to identify the silent-suffering subset.

20. The computer-readable storage medium of claim 15, wherein the actions by the entity towards the silent sufferers is selected from a group consisting of refunds, discount offers, coupons, customer service contact, and combination thereof.
